(19) United States
(12) Patent Application Publication
(10) Pub. No.: US 2006/0262224 A1
(43) Pub. Date: Nov. 23, 2006

(54) Apparatus and method for compensating for color of video signal in display device

(75) Inventors: Yeong Ho Ha, Daegu (KR); Yang Ho Cho, Daegu (KR); Jae Cheon Lee, Daegu (KR); Sang Um Choi, Daegu (KR)

Correspondence Address: BIRCH STEWART KOLASCH & BIRCH, PO BOX 747, FALLS CHURCH, VA, 22040-0747, US

(73) Assignee: LG Electronics Inc., Youngdungpo-gu (KR)

(21) Appl. No.: 11/139,778

(22) Filed: May 31, 2005

(30) Foreign Application Priority Data
May 17, 2005 (KR) 10-2005-0041205

(51) Int. Cl. H04N 5/00; H04N 9/64; H04N 9/74

(52) U.S. Cl. 348/582; 348/649; 348/650; 348/624

(57) ABSTRACT

A color compensation apparatus for use in a display device includes a first video signal converter, a color gamut mapping and expansion unit, and a second video signal converter. The first video signal converter converts RGB values of a first video signal into first color stimulus values, and the color gamut mapping expansion unit performs a color gamut mapping and expansion process on the first color stimulus values in order to obtain second color stimulus values. The second video signal converter then converts the second color stimulus values into a second video signal based on property information of the display device. The second signal converter includes a plurality of modeling units for converting the second color stimulus values, which are divided for a plurality of channels, into image data of a second video signal using a plurality of modeling functions, respectively.

This application claims the benefit of Korean Patent Application No. 10-2005-0041205, filed on May 17, 2005, which is hereby incorporated by reference as if fully set forth herein.

### BACKGROUND OF THE INVENTION

1. Field of the Invention

The present invention relates to a display device, and more particularly, to an apparatus and method for compensating for a color of a video signal for use in a display device capable of allowing a plurality of images received from various input sources to be reproduced with the same color.

2. Discussion of the Related Art

Generally, when video signals generated from different input sources are displayed on only one display device, colors of the video signals are reproduced in slightly different colors. For example, although the same broadcast program is supplied to the display device via air waves and a satellite, colors of the broadcast program displayed on the display device vary slightly depending upon the input sources. Although the same image is displayed on different display devices, the image has different colors according to the display devices.

In order to solve the above-mentioned problem, there must be used a color gamut expansion process which sufficiently uses the range of color expressible by a display device, and at the same time enhances image qualities of both color gamut mapping and input mapping for converting a predetermined color into a similar color expressible by the display device.

Although a standard color gamut of a broadcast signal has been pre-defined, input devices such as a camcorder and a DVD, and output devices such as an LCD, a PDP, and an LCD projection have been designed to have different color expression ranges according to production companies. Therefore, a color gamut mapping process and a color gamut expansion process have been widely used to calibrate colors of the output devices.

A conventional color gamut mapping and expansion method has been carried out in uniform color stimulus spaces (CIELAB, CIECAM97 . . . ) in which human visual characteristics are reflected. However, the conventional color gamut mapping and expansion method requires a predetermined process for converting a color space of a display device into uniform color spaces, and must establish a three-dimensional boundary of a color gamut expressible by the above-mentioned display device in the uniform color space. In this manner, the above-mentioned conventional color gamut mapping and expansion method includes complicated processes, must implement hardware so as to be directly applied to moving images, and increases the number of calculations and operations.

### SUMMARY OF THE INVENTION

Accordingly, the present invention is directed to an apparatus and method for compensating for a color of a video signal in a display device that substantially obviate one or more problems due to limitations and disadvantages of the related art.

An object of the present invention is to provide an apparatus and method for compensating for a color of a display device capable of constantly reproducing a color of an image or video signal using a simplified process.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a color compensation method for use in a display device includes the steps of (a) converting RGB values of a first video signal into first color stimulus values, respectively, (b) performing a color gamut mapping and expansion process on the first color stimulus values in order to obtain second color stimulus values, and (c) converting the second color stimulus values into a second video signal on the basis of property information of the display device.

In another aspect of the present invention, a color compensation apparatus for use in a display device includes a first video signal converter for converting RGB values of a first video signal into first color stimulus values, a color gamut mapping and expansion unit for performing a color gamut mapping and expansion process on the first color stimulus values in order to obtain second color stimulus values, and a second video signal converter for converting the second color stimulus values into a second video signal on the basis of property information of the display device. Herein, the second video signal converter may include a matrix converter for dividing the second color stimulus values for a plurality of channels, a brightness compensator for compensating for brightness values of the divided second color stimulus values, and a plurality of modeling units for converting the divided second color stimulus values into image data of the second video signal using a plurality of modeling functions, which are preset for the plurality of channels, respectively.

In a further aspect of the present invention, a color compensation method for use in a display device includes the steps of (a) performing a color gamut mapping and expansion process on first color stimulus values converted from RGB values of a first video signal in order to output second color stimulus values, (b) dividing the second color stimulus values for a plurality of channels, and (c) converting the divided second color stimulus values into a second video signal using a plurality of modeling functions, which are preset for the plurality of channels, respectively.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a color compensation apparatus according to the present invention;

FIG. 2 is a block diagram illustrating a second video signal converter (i.e., an inverse GOG model based on 9 channels) of FIG. 1 according to the present invention;

FIG. 3 is a graph illustrating an ITUBT.709 chromatic value under a D65 light source and a chromatic value created by Bradford conversion for a PDP white reference point according to the present invention;

FIG. 4 is a graph illustrating a color gamut of a display device in an xy color space according to the present invention;

FIG. 5 is a graph illustrating a method for expanding a color gamut in an xy color space according to the present invention;

FIG. 6 shows a common range in which a color gamut expansion process is not applied according to the present invention;

FIG. 7 is a flow chart illustrating a method for converting input RGB values into the last output R′G′B′ values according to the present invention; and

FIG. 8 is a flow chart illustrating a matrix-shaped process for converting input RGB values into the last output R′G′B′ values according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

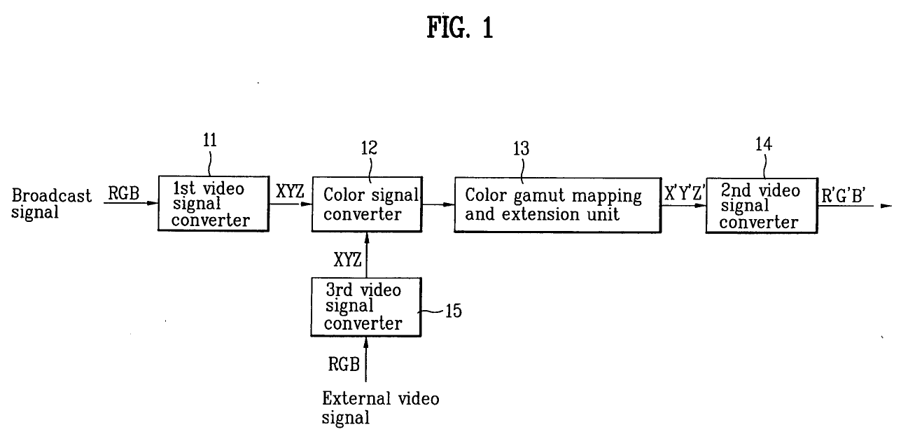

FIG. 1 is a block diagram illustrating a color compensation apparatus according to the present invention. As shown in FIG. 1, a first video signal converter 11 receives a broadcast signal via air waves, a satellite, and a cable, and converts RGB values of the received broadcast signal into X, Y, and Z values equal to standard color stimulus values. The first video signal converter 11 samples RGB values of the broadcast signal a predetermined number of times, and converts the sampled RGB values into the standard color stimulus values.

The color signal converter 12 receives the standard color stimulus values from the first video signal converter 11, and adjusts chromatic values of X, Y, and Z values using a chromatic adaptation model of a display device. The chromatic adaptation model is the von Kries model or the Bradford model.

The color gamut mapping and expansion unit 13 receives the standard color stimulus values from the color signal converter 12, and performs a color gamut mapping process and a color gamut expansion process for X, Y, and Z values equal to the standard color stimulus values on the basis of a white point of the display device. Also, the color gamut mapping and expansion unit 13 compares a color gamut of the broadcast signal with that of the display device, and expands color gamuts of X, Y, and Z values equal to the standard color stimulus values according to a difference between the color gamuts of the broadcast signal and the display device.

A second video signal converter 14 receives the standard color stimulus values of X, Y, and Z generated from the color gamut mapping and expansion unit 13, and converts the standard color stimulus values into expressible video data on the basis of the characterization model of the display device. In this case, the characterization model is indicative of the GOG (Gain Offset Gamma) model based on 9 channels.

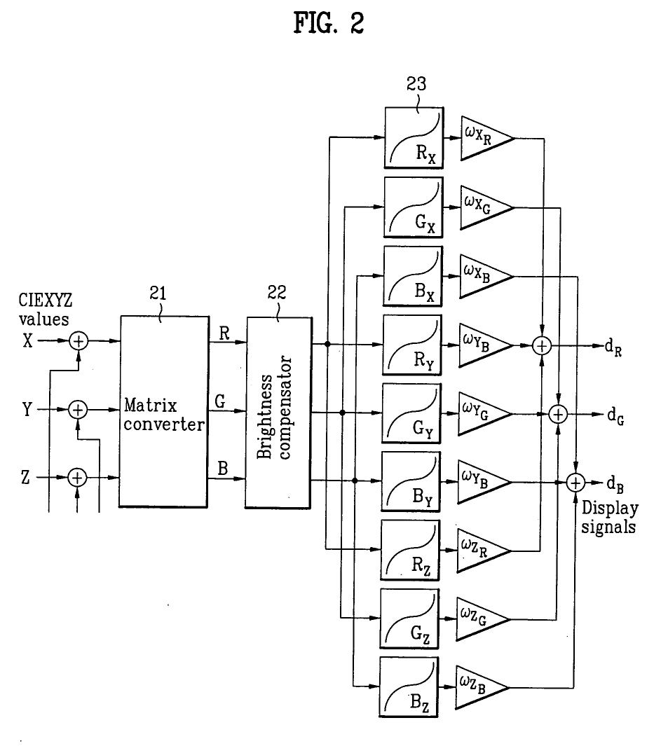

As shown in FIG. 2, the second video signal converter 14 includes: a matrix converter 21 for dividing the standard color stimulus values of X, Y, and Z into a plurality of channels; a brightness compensator 22 for compensating for brightness values of X, Y, and Z equal to the standard color stimulus values divided according to channels; and a plurality of modeling unit 23 for substituting X, Y, and Z values equal to the standard color stimulus values divided according to channels into a predetermined function established for each channel, and calculating video data to be displayed.

A third video signal converter 15 receives an external video signal from an external device such as a DVD player or VCR, and determines category information of the received external video signal. And, the third video signal converter 15 converts R, G, and B values of the received external video signal into X, Y, and Z values indicative of the standard color stimulus values, and transmits the X, Y, and Z values to the color signal converter 12.

A color compensation method according to the present invention will hereinafter be described.

In order to correctly express the same input video signal in an output video signal, a color operation/management system capable of considering a white reference point of each device, and a color gamut range expressible by each device is needed. In other words, in order to reproduce a correct color, a difference between white reference points of input and output signals must be compensated using a chromatic adaptation model based on human visual characteristics, and a color gamut mapping technique and a color gamut expansion technique which adjust a expressible color gamut range must be used.

In the case of the ITUBT.709 signal indicative of an HDTV standard broadcast input signal, a white reference point is defined as D65. But, in the case of other output devices for reproducing the same color, for example, a PDP, an LCD, and an LCD projection, a white reference point ranges from 9000K to 11000K. Therefore, if two devices have different white reference points, a chromatic adaptation model based on human visual characteristics to reproduce the same color in an environment having different white reference points must be applied to the two devices. Since a color gamut of the ITUBT.709 input signal is relatively less than those of a PDP, an LCD, and an LCD projection, a color operation/management system capable of performing a color gamut mapping process and a color gamut expansion process is required to reproduce an optimum value depending on output devices. A Bradford conversion model is adapted to optimize accuracy and performance for white reference point conversion. In the case of the color gamut mapping and expansion process, color gamut conversion is performed on xy planes indicative of chromatic coordinates such that a color value and a maximum chroma are simultaneously maintained.

A reference light source of a value defined in ITU.BT-709 as an HDTV standard broadcast signal is D65, and xy chromatic coordinates of the white reference point are (0.3127,0.329). In the case of chromatic values of three primary colors (i.e., RGB values), a chromatic value of the Red signal is (0.64, 0.33), a chromatic value of the Green signal is (0.3, 0.6), and a chromatic value of the Blue signal is (0.15, 0.06). A conversion function for converting linearized RGB values into CIEXYZ values is shown in the following equation 1:

$$[ \begin{matrix}X \\ Y \\ Z\end{matrix} ] = [ \begin{matrix}0.412 & 0.358 & 0.18 \\ 0.213 & 0.715 & 0.072 \\ 0.019 & 0.119 & 0.95\end{matrix} ] [ \begin{matrix}R \\ G \\ B\end{matrix} ] \qquad [ Equation 1 ]$$

Inverse conversion of the above equation 1 is shown in the following equation 2.

$$[ \begin{matrix}R \\ G \\ B\end{matrix} ] = [ \begin{matrix}3.241 & - 1.537 & - 0.499 \\ - 0.969 & 1.876 & 0.042 \\ 0.056 & - 0.204 & 1.057\end{matrix} ] [ \begin{matrix}X \\ Y \\ Z\end{matrix} ] \qquad [ Equation 2 ]$$

There is a conversion function based upon I/O (Input/Output) operations in the case of a standard broadcast signal, such that the conversion function is used as an input value of each display device.

ITUBT.709 signal serving as an HDTV standard broadcast signal is converted into the CIEXYZ values using the above-mentioned conversion functions, and the converted result is calculated as xy chromatic coordinate values using the following equation 3:

$$x = \frac{X}{X + Y + Z} , y = \frac{Y}{X + Y + Z} \qquad [ Equation 3 ]$$

If a display device establishes a predetermined value correctly coping with the standard broadcast signal specification, it is possible to express a correct color. However, generally, individual display devices have different color temperatures, different chromatic values and different color gamut values in association with their primary color components, such that a proper color operation/management system must be used.

A color temperature of a display device is calculated by applying a white value (R=255, G=255, and B=255) to the display device, and CIEXYZ values are measured by a color measurement device (also called a colorimeter), such that the color temperature of the display device can be calculated. In the case of an output display device, a color temperature of more than 9000K is established by a white color preference of a domestic display device, differently from a color temperature of 6503K of the standard HDTV signal. In other words, a white point of the standard broadcast signal is not determined to be the D65 light source, and is determined to be a high color temperature by which a color more similar to a blue color is established. Therefore, a color temperature of the display device must be measured, and an input signal must be converted into a signal based on a white point of a device corresponding to the D65 light source upon receipt of the measured color temperature.

Color stimulus for allowing a user to differently perceive a color due to a color and intensity of a white reference point is called color non-identity. The ITUBT.709 signal indicative of a standard input signal is defined as color stimulus under the D65 light source. However, in order to express the above-mentioned ITUBT.709 signal acting as the standard input signal on the output display devices including a white reference point ranging from 9300K to 11000K, for example, a PDP, an LCD, and an LCD projection, a chromatic adaptation process is needed. In order to convert the CIEXYZ values into other values according to light sources, the von Kries model, a representative chromatic adaptation linear model, and the Bradford model, a representative nonlinear model, are used. The von Kries model indicative of the linear model has a simplified operation process but lower calculation accuracy. The Bradford model, a representative nonlinear model has high model complexity, but it can induce a correct conversion relationship.

The above-mentioned von Kries model assumes that only a maximum stimulus proportional coefficient when a chromatic adaptation process under specific illumination is changed to other chromatic adaptation process under other illuminations is changed, such that the following linear conversion equation can be provided:
Lₐ=k_{L}L
Mₐ=k_{M}M
Sₐ=k_{S}S [Equation 4]

In this case, L, M, and S are cone responses in an initial state, Lₐ, Mₐ, and Sₐ are cone responses after the chromatic adaptation process has been performed, and k_{L}, k_{M}, and k_{S} are sensitivity proportional coefficients multiplied by the initial state output signals of three cones. In the case of the von Kries model, proportional coefficients k_{L}, k_{M}, and k_{S} are inverse numbers of a maximum stimulus value of the white reference point, and can be calculated using the following equation 5:

$${k}_{L} = \frac{1}{{L}_{white}} , {k}_{M} = \frac{1}{{M}_{white}} , {k}_{S} = \frac{1}{{S}_{white}} \qquad [ Equation 5 ]$$

Therefore, when corresponding colors are provided under first and second adaptation conditions, the von Kries model can be represented by the following equation 6:
Lₐ=k_{L1}L₁=k_{L2}L₂
Mₐ=k_{M1}M₁=k_{M2}M₂
Sₐ=k_{S1}S₁=k_{S2}S₂ [Equation 6]

The relationship between two corresponding colors can be represented by the following equation 7:

$${L}_{2} = \frac{{L}_{1}}{{L}_{white 1}} \times {L}_{white 2} \\ {M}_{2} = \frac{{M}_{1}}{{M}_{white 1}} \times {M}_{white 2} \\ {S}_{2} = \frac{{S}_{1}}{{S}_{white 1}} \times {S}_{white 2} \qquad [ Equation 7 ]$$

However, although the above-mentioned von Kries model easily establishes a conversion relationship, and has a simplified calculation process, a chromatic adaptation process is carried out using only linear conversion when there is a high difference between two illumination light signals or severe overlapping between primary color spectrums occurs, resulting in reduction of accuracy.

In order to negate disadvantages of the von Kries model, intensive research into a variety of nonlinear models has been conducted. Particularly, a representative research indicative of the most correct chromatic adaptation model application method from among recent experimental results of the international illumination organization (CIE) is the Bradford chromatic adaptation model. The Bradford chromatic adaptation model is applied to the CIECAM97s chromatic space model, such that it is used as the principal element for the human visual characteristic modeling in which a white reference point variation is reflected.

Firstly, color coordinates of each device are converted into CIEXYZ values, and the CIEXYZ values are converted into RGB values of a cone cell using the following equation 8:

$$[ \begin{matrix}R \\ G \\ B\end{matrix} ] = [ \begin{matrix}0.8591 & 0.2664 & - 0.1614 \\ - 0.7502 & 1.7135 & 0.0367 \\ 0.0389 & - 0.0685 & 1.0296\end{matrix} ] [ \begin{matrix}\frac{X}{Y} \\ \frac{Y}{Y} \\ \frac{Z}{Y}\end{matrix} ] \qquad [ Equation 8 ]$$

Reference stimulus values R′, G′, and B′ to be converted can be represented by the following equation 9:
R′=R′_{w}(R/R_{w})
G′=G′_{w}(G/G_{w})
B′=B′_{w}(B/B_{w})^{p} [Equation 9]

In this case, R′_{w}, G′_{w}, and B′_{w} are indicative of the maximum values of a white reference point to be converted, and R_{w}, G_{w}, and B_{w} are indicative of the maximum values of an input white reference point. An exponential value p applied to calculate the B′ value can be calculated by the following equation 10:
p=(B_{w}/B_{w}′)^{0.0834} [Equation 10]

CIEX′Y′Z′ values equal to the last color adaptation conversion values of the converted R′G′B′ values can be represented by the following equation 11:

$$[ \begin{matrix}{X}^{′} \\ {Y}^{′} \\ {Z}^{′}\end{matrix} ] = {[ \begin{matrix}0.8591 & 0.2664 & - 0.1614 \\ - 0.7502 & 1.7135 & 0.0367 \\ 0.0389 & - 0.0685 & 1.0296\end{matrix} ]}^{- 1} [ \begin{matrix}\frac{{R}^{′}}{Y} \\ \frac{{G}^{′}}{Y} \\ \frac{{B}^{′}}{Y}\end{matrix} ] \qquad [ Equation 11 ]$$

Therefore, a broadcast signal according to the present invention sets the D65 light source to a white reference point, and a display device indicates a white reference point of more than 9300K, such that the Bradford conversion model is adapted to perform white reference point conversion.

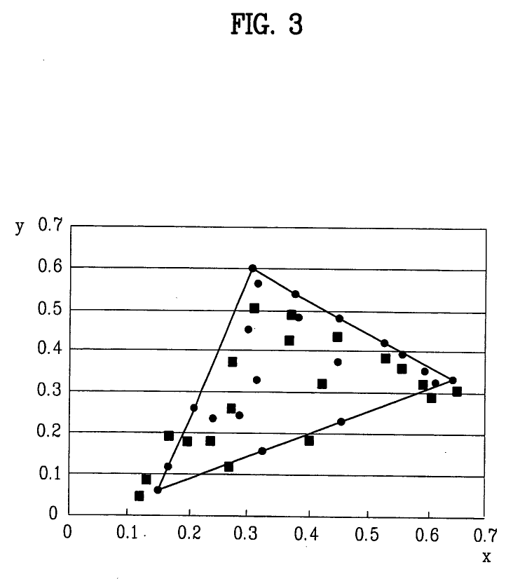

Provided that the input signal is an ITUBT.709 signal, the Macbeth chart image is converted into CIEXYZ values, and the Bradford chromatic adaptation model is used, such that the CIEX′Y′Z′ values can be calculated. FIG. 3 shows the Macbeth chart image, which is represented by chromatic values (xy) expressed under the D65 light source acting as an input signal and other chromatic values (x′y′) created by the Bradford chromatic adaptation conversion. CIEXYZ values of the Macbeth chart image are acquired by a predetermined conversion relationship equation defined in the ITUBT.709 signal. The CIEXYZ values are denoted by black circles (●). If the Bradford chromatic adaptation conversion model for a PDP white reference point is applied to the CIEXYZ values under the D65 light source, and the resultant value is converted into chromatic coordinates, the conversion result is denoted by squares (▪) in FIG. 3. A triangle drawn by a solid line is indicative of a color gamut of the ITUBT.709 signal acting as an input signal.

Chromatic coordinates are differently recognized by a human being according to categories of light sources, such that a chromaticity variation in which light source characteristics are reflected must be converted into another variation using the chromatic adaptation model. Therefore, if the ITUBT.709 signal acting as the input signal is converted into another signal on the basis of a white point of each device, CIEXYZ_{Device-white} values of the display device can be acquired.

The Bradford chromatic adaptation conversion is applied to a white reference point of the input signal and a white reference point of the output signal, such that the white reference points of the input and output signals are converted into others. If the distribution of the converted value is converted into a chromatic color gamut of the input signal and the other chromatic color gamut of the output display device, there arises an unexpected area escaping from a threshold value of a color gamut of a PDP acting as an output device when the Macbeth chart image is converted into other values using the chromatic adaptation conversion. Therefore, the color gamut mapping process is applied to a value escaping from the color gamut after performing the chromatic adaptation model, such that an inexpressible color can be expressed in the most similar color.

The color mapping process is adapted to express a color escaping from a color gamut in the most similar color, such that it can enhance color reproducibility. In the case of a general color gamut mapping process, there has been studied a method for performing the color mapping process based on the optimum value using color-, brightness-, and chroma values in the CIELAB color space in which human visual characteristics are reflected. However, if the color gamut mapping process is performed in the CIELAB space, it is difficult to establish a threshold value of the color gamut whereas performance of the color gamut mapping process is improved, resulting in an increased number of calculations.

The color mapping method is classified into a color gamut compression method, and a color gamut cutting method. The above-mentioned color gamut compression method maps an external value of a color gamut to a threshold value of the color gamut. The color gamut cutting method compresses the color gamut external value into a color gamut internal value, and performs the color mapping process on the compressed result. In order to correctly express a grey level of an image or video signal, the color gamut compression method is very effective, but color gamut internal values are unexpectedly changed, resulting in a high color difference. However, the color gamut cutting method may encounter the color overlapping phenomenon, but it has superior color mapping results when a color gamut difference is not high.

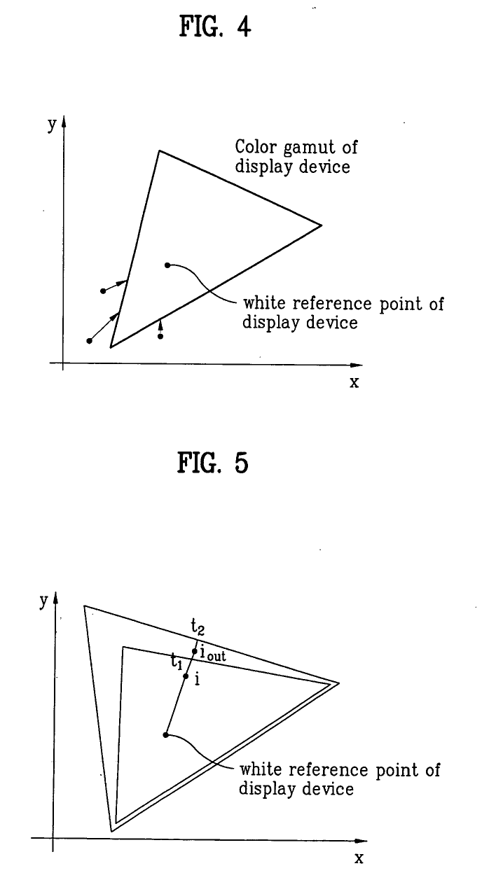

In order to effectively apply concepts of the present invention to moving images of a DTV, the color gamut mapping technique is derived from the CIExy color space instead of the CIELAB color space in which it is difficult to determine/calculate a color gamut threshold value, and the color gamut cutting method for mapping the color gamut external value to the color gamut threshold value is used. In other words, there is used the color gamut mapping technique, which is capable of maintaining a desired color in the xy color space indicative of a chromatic plane simultaneously with cutting the color by the maximum chroma area. If a straight line is made on the basis of a white point of a device in the xy plane, the same color value can be maintained. In order to maintain the maximum chroma, a value escaping from the color gamut can be mapped by an intersection point, which is formed when a line for connecting a predetermined point outside of the color gamut to a white point of a device meets a color gamut boundary. FIG. 4 shows a method for mapping a color outside of the color gamut of a display device on the basis of the white point.

An input brightness value Y and xy values created by the color gamut mapping process can be acquired, such that the last X and Z values can be calculated by the following equation 12:
X+Y+Z=T [Equation 12]

The sum of CIEXYZ tri-stimulus values can be denoted by the above equation 12. A method for acquiring xy chromatic coordinates from the CIEXYZ values is shown in the following equation 13:

$$\frac{X}{T} = x \\ \frac{Y}{T} = y \qquad [ Equation 13 ]$$

Y and y values acquired after performing the color gamut mapping process can be aquired using the above equations 12 and 13, such that a T value can be derived. If the T value is substituted into the above equations 12 and 13, an X value can be derived. If the X value is substituted into the above equations 12 and 13, a Z value can be derived.

After the chromatic adaptation conversion is applied to the Macbeth chart image, if the color gamut mapping process is applied to colors outside of the color gamut in an xy chromatic plane such that the resultant xy values are derived, it can be recognized that the colors outside of the color gamut have chromatic coordinates which are cut by a color gamut boundary for the white reference point in the xy plane.

If a color gamut of the ITUBT.709 signal indicative of the standard input signal and color gamuts of output devices (e.g., a PDP, an LCD, and an LCD projection) are expressed in a color space of the xy chromatic values, it can be recognized that a color gamut of an input signal is relatively narrower than those of the output devices. In other words, if the ITUBT.709 signal acting as an input signal is applied to the output device without any change, the ITUBT.709 signal has a color gamut smaller than the other color gamut expressible by the output device, such that a grey level of an image displayed on the output device is decreased.

In order to obviate the above-mentioned disadvantages, there is needed a color gamut expansion technique for expanding a color gamut of the input signal to a color gamut of the output device. The color gamut expansion technique applied to the present invention is performed in the color space of the xy chromatic values on the basis of the color gamut mapping technique.

Similar to the color gamut mapping technique, an input color stimulus value is expanded by the ratio of a color gamut magnitude value of the input signal to that of the output display device on the basis of the white reference point. FIG. 5 shows a color gamut expansion process. Referring to FIG. 5, if an input value (i) is received, a first distance from the white point (0) of the device to a first threshold point (t1) of the input signal color gamut and a second distance from the white point (0) of the device to a second threshold point (t2) are measured, the ratio of the first distance to the second distance is calculated, such that the input value (i) is expanded by the ratio of the first distance to the second distance, resulting in the resultant value of iₒᵤₜ. A conversion equation for performing the aforementioned color gamut expansion is denoted by the following equation 14:

$${i}_{out} = α \times \vert \frac{{O}^{->} {t}_{2}}{{O}^{->} {t}_{1}} \vert \times \vert {O}^{->} i \vert \qquad [ Equation 14 ]$$

In this case, α is indicative of a coefficient for determining the degree of color gamut expansion. If the α value is properly adjusted, a chroma of an input image is increased, such that the input image is able to have a high chroma. Basically, if the α value is set to a predetermined value of 1, a threshold value of the input signal can be converted into that of the output signal.

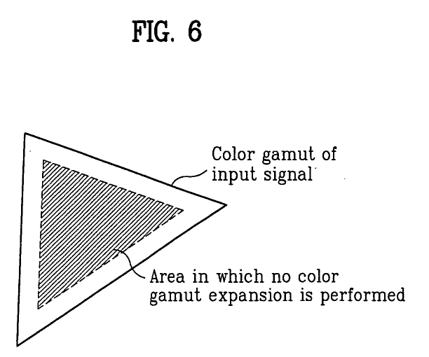

However, since individual display devices have different expressible color gamuts, the ranges of object colors for color gamut expansion must be limited. In other words, when the color gamut expansion is performed in only a specific area of the input signal color gamut, and variation of the color gamut expansion is not applied to a common area, the same color can be reproduced. FIG. 6 shows a color gamut of the ITUBT.709 signal acting as an input signal and an oblique-lined area in which no color gamut expansion occurs in the input signal color gamut. In the example shown in FIG. 6, the oblique-lined area is determined to be an area corresponding to 80% of the magnitude of the input signal color gamut. Finally, a color gamut expansion algorithm is applied to an area escaping from a common color gamut, such that a color expressible by the device can be correctly expressed.

If a chromatic value is acquired after the color gamut expansion technique for a PDP device is applied to the Macbeth chart image, and is expressed in xy coordinates, it can be recognized that a chroma of the chromatic coordinates is increased on the basis of the white point of the display device.

When indicating the increased chroma value by adjusting a proportional coefficient for chroma improvement, it can be noted that the chroma value of an image is increased in proportion to the proportional coefficient.

In the case of the ITUBT.709 signal acting as the standard input signal, an absolute brightness value (Y) is not correctly defined, but is defined as a relative ratio of CIEXYZ values. If the Y value associated with the white point is normalized to a predetermined value of 1, a corresponding X value is 0.95, and a corresponding Z value is 1.08. Therefore, in order to display the Y value on a target display device, the Y value must be converted into the maximum Y value measured by the target display device. In the case of PDP, LCD, and LCD projection, a saturation area exists in a level having RGB values, each of which is higher than 230. If a corresponding value is extracted from the device including the above saturation area using the maximum brightness value of the device, a grey level is decreased.

If a brightness value is converted into another brightness value to express a color similar to a unique brightness characteristic of the display device, a brightness value is adjusted to be suitable for input characteristics under a low grey level, and is saturated under a high grey level. Also, a two-stage mapping process is applied to a low grey level and a high grey level. An original brightness value is maintained under the low grey level. Under the high grey level, a linear compression method is used so that a grey level having a brightness value suitable for the display device is expressed. The grey level expression for the brightness value can be denoted by the following equation:

$${Y}_{output} = [ \begin{matrix}Y , & if Y < {Y}_{threshold} \\ ( Y - {Y}_{threshold} ) \times \frac{{Y}_{device\_max} - {Y}_{threshold}}{{Y}_{n}^{′} - {Y}_{threshold}} + {Y}_{threshold} , & otherwise\end{matrix} \qquad [ Equation 15 ]$$

In this case, Y is an input brightness value, Y_{threshold} occupies 70% of the maximum brightness value of the device, Yₙ′ is a maximum value determined to express a grey level in the brightness value of the input signal, and Y_{device}_{_{—}}ₘₐₓ is a maximum brightness value of the device. In this way, since the grey level expression of the brightness value is carried out as described above, the grey level of the brightness value can be expressed to be suitable for characteristics of the device.

In order to guarantee reliability of a color reproduced according to the characteristics of the display device, device characterization, expressible color range, and peripheral viewing environments must be considered. There have been intensively studied a variety of display devices, for example, CRT-based TVs, projection TVs, PDPs, and LCDs, etc. However, the above-mentioned output devices employ different output schemes, for example, luminescence of a fluorescent material due to electronic beam, luminescence of a fluorescent material due to gas discharge, arrangement variation of liquid crystal molecules due to a voltage difference of a glass plate electrode, etc. Therefore, due to the above-mentioned output scheme difference, a high difference occurs in a reproduced color.

Generally, a CRT has little variation in a correlation color temperature associated with both chromatic coordinates of three primary colors and a gray scale according to input values of three primary colors RGB, such that a relatively-correct color can be reproduced. However, the LCD has a very high variation in the correlation color temperature associated with both the chromatic coordinates and the grey scale according to RGB input values. Particularly, the PDP has a disadvantage in that it is unable to use maximum brightness values of Red and Green cells due to low brightness characteristics of a Blue cell. Therefore, due to color reproducibility of each output device, there is a high difference in output color stimulus values of the standard input RGB signals. In more detail, if the RGB values corresponding to predetermined color stimulus values (XoYoZo) are entered, stimulus values (X_{A}Y_{A}Z_{A} . . . ) generated from individual devices are different from each other.

An object of a TV capable of implementing color reproducibility is to output the same color stimulus value as in an original image, irrespective of categories of used input and output devices. However, due to a difference between transfer characteristics of the input and output devices and a difference between color gamuts of individual devices, there is a color difference between the original image and a reproduced image.

In this manner, if an independent correction process is not applied to the original image, different output stimuli are generated according to categories of output devices. Therefore, in order to overcome the above-mentioned color difference, the correct modeling of transfer characteristics of various output devices is performed, and at the same time a device-independent color conversion process is also performed. According to the present invention, characterization functions of a PDP and an LCD were investigated, and the resultant characterization functions are applied to the present invention.

Corresponding CIEXYZ values are measured on the basis of RGB values acting as an input signal, and a conversion model can be estimated on the basis of the measured CIEXYZ values, such that characterization of a display device is performed.

In order to perform characterization of a display device, each of RGB values is divided into 8 sections, the equally-divided values are applied to the display device, and the CIEXYZ values acting as the standard stimulus values are acquired using a Minolta CS-100 spectro-radiometer. A measurement process is performed under the international standard environment (IEC), and is performed under the condition that the display device is in an initial state. After preheating the display device for more than 1 hour, the preheated display device is measured in a dark room at a predetermined distance of more than four times the height of the display device. The size of a measurement patch corresponds to ⅕ of the display device's height, the measurement patch is located at the center of the display device, and a background color is determined to be a black color.

The number of sample patches used for characterization of the display device is 27. A measurement process is performed on 27 sample patches composed of nine R sample patches, nine G sample patches, and nine B sample patches, the relationship equation of CIEXYZ values corresponding to the RGB values is modeled on the basis of the measured values, and I/O (Input/Output) characteristics of the display device are modeled.

A representative characterization model for the display device is a GOG (Gain Offset Gamma) model, and the GOG model has been developed to be applied to the CRT. A voltage applied to the CRT is proportional to digital values from 0 to 255, and a beam current has exponential characteristics associated with the voltage. A light brightness of a phosphorescent substance is proportional to the beam current. Therefore, I/O characteristics between a digital value provided to the CRT and a CRT light brightness can be represented by gain, offset, and gamma values, and can be denoted by the following equation 16:

$$R = \{ \begin{matrix}\{ {[ {k}_{g , r} ( \frac{{d}_{r}}{{2}^{N} - 1} ) + {k}_{o , r} ]}^{{γ}_{r}} , & [ {k}_{g , r} ( \frac{{d}_{r}}{{2}^{N} - 1} ) + {k}_{o , r} ] \geq 0 \\ 0 , & [ {k}_{g , r} ( \frac{{d}_{r}}{{2}^{N} - 1} ) + {k}_{o , r} ] < 0\end{matrix} \\ G = \{ \begin{matrix}\{ {[ {k}_{g , g} ( \frac{{d}_{g}}{{2}^{N} - 1} ) + {k}_{o , g} ]}^{{γ}_{g}} , & [ {k}_{g , g} ( \frac{{d}_{g}}{{2}^{N} - 1} ) + {k}_{o , g} ] \geq 0 \\ 0 , & [ {k}_{g , g} ( \frac{{d}_{g}}{{2}^{N} - 1} ) + {k}_{o , g} ] < 0\end{matrix} \\ B = \{ \begin{matrix}\{ {[ {k}_{g , b} ( \frac{{d}_{b}}{{2}^{N} - 1} ) + {k}_{o , b} ]}^{{γ}_{b}} , & [ {k}_{g , b} ( \frac{{d}_{b}}{{2}^{N} - 1} ) + {k}_{o , b} ] \geq 0 \\ 0 , & [ {k}_{g , b} ( \frac{{d}_{b}}{{2}^{N} - 1} ) + {k}_{o , b} ] < 0\end{matrix} \qquad [ Equation 16 ]$$

In the above equation 16, d is a normalized value of the digital value given to a channel, kg is a gain, and ko is an offset value. If gain, offset, and gamma values of each channel are estimated, the modeling between the digital value and the light brightness is completed, and a matrix operation is performed to estimate CIEXYZ values. The value of each column of the matrix is the maximum CIEXYZ values of each channel. The above-mentioned matrix operation is performed on the assumption that individual channels of RGB signals are independent of each other and an additive formula is formed in the CIEXYZ values, such that it can be represented by the following equation 17:

$$[ \begin{matrix}X \\ Y \\ Z\end{matrix} ] = [ \begin{matrix}{X}_{r , max} & {X}_{g , max} & {X}_{b , max} \\ {Y}_{r , max} & {Y}_{g , max} & {Y}_{b , max} \\ {Z}_{r , max} & {Z}_{g , max} & {Z}_{b , max}\end{matrix} ] [ \begin{matrix}R \\ G \\ B\end{matrix} ] \qquad [ Equation 17 ]$$

In the above equation 17, RGB values are determined considering gain, offset, and gamma characteristics, and CIEXYZ values are acquired using the RGB values. By the above-mentioned process, characterization of input and output values of the display device is performed. Although the GOG model has been developed to perform CRT characterization, it has a small number of calculations and is easily implemented, such that it can also be easily applied to other display devices. When performing the characterization modeling process, the relationship between a brightness value Y corresponding to the input RGB values and a channel associated with the brightness value Y is only estimated and used, such that there is no consideration of correlation between channels.

If electricity-to-light I/O characteristics of a display device in association with XYZ values in a conventional GOG model are measured, and the measured results are shown in a graph, it can be recognized that individual XYZ values have different electricity-to-light I/O characteristics. In more detail, the conventional GOG model assumes that electricity-to-light I/O curves of XYZ values corresponding to the RGB values are equal to each other, and is used when X and Z values are calculated by modeling only the electricity-to-light I/O curve of the brightness value Y (also called a luminance value Y), such that a great error occurs when a characterization process is performed. Therefore, XYZ values are modeled, respectively, and the modeled XYZ values are adapted to the characterization process, such that accuracy of the characterization can be increased. The present invention provides an improved algorithm capable of modeling the electricity-to-light I/O curve of the display device in association with the XYZ values, and performing the characterization process. As a result, compared with a method for modeling the electricity-to-light I/O curve of a single Y value, the present invention can increase accuracy of the characterization process.

The characterization modeling of nine channels is carried out using the measured CIEXYZ values, resulting in increased accuracy of the modeling process. Nine gain values, nine offset values, and nine gamma values are derived as estimation values of the modeling process.

The improved GOG display characterization model independently models electricity-to-light I/O curves of individual RGB channels in consideration of different electricity-to-light I/O curves associated with XYZ values of the display device. When estimating the Y value, an electricity-to-light I/O curve of the Y value acquired from individual channels is used. When estimating the X and Z values, an electricity-to-digital I/O curve of the Y value is not uses, the X value is estimated by an electricity-to-digital I/O curve of an X value acquired from individual channels, and the Z value is estimated by an electricity-to-digital I/O curve of a Z value acquired from individual channels. The final XYZ values can be calculated by the following equation 18 according to linear conversion in the same manner as in the conventional model:

$$X = [ \begin{matrix}{X}_{r , max} & {X}_{g , max} & {X}_{b , max}\end{matrix} ] [ \begin{matrix}{X}_{R} \\ {X}_{G} \\ {X}_{B}\end{matrix} ] \\ Y = [ \begin{matrix}{Y}_{r , max} & {Y}_{g , max} & {Y}_{b , max}\end{matrix} ] [ \begin{matrix}{Y}_{R} \\ {Y}_{G} \\ {Y}_{B}\end{matrix} ] \\ Z = [ \begin{matrix}{Z}_{r , max} & {Z}_{g , max} & {Z}_{b , max}\end{matrix} ] [ \begin{matrix}{Z}_{R} \\ {Z}_{G} \\ {Z}_{B}\end{matrix} ] \qquad [ Equation 18 ]$$

In the above equation 18, Xₘₐₓ, Yₘₐₓ, and Zₘₐₓ are indicative of CIEXYZ values of an output light when the highest digital value used as an input signal is applied to individual channels, and X_{R}, X_{G}, X_{B}, Y_{R}, Y_{G}, Y_{B}, Z_{R}, Z_{G}, and Z_{B} are indicative of values corresponding to Red, Green, and Blue channels calculated by estimating gain, offset, and gamma values.

In the case of a PDP display device, XYZ values are not similar to those of the GOG model under a low grey level. Therefore, if the GOG model is applied to the PDP display device, a high error occurs in the PDP display device. In more detail, although RGB values of more than a predetermined level are used as an input signal in the PDP display device, there is little variation in XYZ values corresponding to the RGB values. Therefore, a predetermined area in which the RGB values are changed but XYZ values corresponding to the RGB values are not changed is linearly modeled instead of using the GOG model, the GOG model is applied to values generated after the linear modeling process. Although RGB values are changed by about a predetermined value of 60, a corresponding Y value is changed by about a predetermined value of 1. Therefore, the linear modeling process is performed in a low grey level area, and the GOG modeling process is performed since a specific value and over. As a result, by the above-mentioned process, the present invention supplements characteristics incapable of being estimated by the GOG model, such that a color difference between modeling processes is decreased.

The improved GOG model and the low grey level model are applied to the display device, a color difference is decreased compared with the conventional GOG model, and display characterization can be generalized. When drawing characterization curves of XYZ values associated with RGB values in the PDP display device, the PDP display device has low-increment XYZ values under a low grey level, and has a saturation area under a high grey level. Generally, it can be recognized that individual characterization curves of XYZ values associated with RGB values are similar to each other. An average color difference is correctly modeled as a value of less than “2” capable of satisfying recognition limitations of human visual characteristics.

When drawing a characterization curve of XYZ values associated with RGB values in the LCD display device, the LCD has a saturation area in which the XYZ values are abruptly saturated under a high grey level, such that it can be recognized that modeling accuracy is less than that of the PDP display device. There is little variation in the Z value associated with the R channel.

In the case of the GOG model, if a forward characterization process for estimating CIEXYZ values corresponding to RGB values is inversely executed, RGB values corresponding to the CIEXYZ values can be obtained. However, an improved GOG model is unable to perform the inverse mathematical process. The forward characterization process is able to correctly estimate nine CIEXYZ values corresponding to the RGB values through the use of a measurement process. An inverse conversion process is unable to estimate nine RGB values corresponding to the CIEXYZ values. If the input XYZ values are applied to the improved GOG model, values to be estimated by an inverse transform matrix can be represented by the following equation 19:

$${[ \begin{matrix}{X}_{r , max} & {X}_{g , max} & {X}_{b , max} \\ {Y}_{r , max} & {Y}_{g , max} & {Y}_{b , max} \\ {Z}_{r , max} & {Z}_{g , max} & {Z}_{b , max}\end{matrix} ]}^{- 1} {[ \begin{matrix}X \\ Y \\ Z\end{matrix} ]}_{Input value} \neq [ \begin{matrix}{R}_{X} & {R}_{Y} & {R}_{Z} \\ {G}_{X} & {G}_{Y} & {G}_{Z} \\ {B}_{X} & {B}_{Y} & {B}_{Z}\end{matrix} ] \begin{matrix}Values to be estimated \\ for Inverse transform\end{matrix} \qquad [ Equation 19 ]$$

In the above equation 19, R_{X}, R_{Y}, R_{Z}, G_{X}, G_{Y}, G_{Z}, B_{X}, B_{y}, and B_{Z} are indicative of values to be estimated for an inverse transform, but they are not provided in a mathematical transform process. Therefore, in order to estimate the above inverse transform process, it is assumed that RGB values are linearly proportional to CIEXYZ values. In order to reduce errors of the last output RGB values, an inverse characterization model of a display device is applied to the last output RGB values using the maximum CIEXYZ values. Correlation between channels is applied to an inverse characterization process, resulting in high characterization performance.

Firstly, initial RGB values in which brightness components (also called luminance components) corresponding to the CIEXYZ values can be acquired by the following equation 20:

$${[ \begin{matrix}{X}_{r , max} & {X}_{g , max} & {X}_{b , max} \\ {Y}_{r , max} & {Y}_{g , max} & {Y}_{b , max} \\ {Z}_{r , max} & {Z}_{g , max} & {Z}_{b , max}\end{matrix} ]}^{- 1} [ \begin{matrix}X \\ Y \\ Z\end{matrix} ] = [ \begin{matrix}{R}_{Y} \\ {G}_{Y} \\ {B}_{Y}\end{matrix} ] \qquad [ Equation 20 ]$$

Channel-dependent values are removed from the acquired values, such that correct XYZ values corresponding to the RGB values are established. In the case of modeling the channel-dependent values, although values of only one channel must exist in brightness values of acquired RGB values, spectral distribution of primary colors are partially overlapped with each other, resulting in the creation of channel-dependent values (i.e., interference components).

Therefore, the present invention models the above-mentioned channel-dependent values in the form of a quadratic equation, removes the channel-dependent values from normalized brightness values calculated by an inverse matrix when predetermined CIEXYZ values are received as input signals, such that it can acquire channel-independent values. A model for removing the channel-dependent values can be represented by the following equation 21:
R_{g,error}=a_{r,g}(G_{primary})²−a_{r,g}(G_{primary})
R_{b,error}=a_{r,b}(B_{primary})²−a_{r,b}(B_{primary})
G_{r,error}=a_{g,r}(R_{primary})²−a_{g,r}(R_{primary})
G_{b,error}=a_{g,b}(B_{primary})²−a_{g,b}(B_{primary})
B_{r,error}=a_{b,r}(R_{primary})²−a_{b,r}(R_{primary})
B_{g,error}=a_{b,g}(G_{primary})²−a_{b,g}(G_{primary}) [Equation 21]

In the above equation 21, C_{i,error} (c=R, G, and B, i=r,g,b) is indicative of channel-dependent values of a G channel based on an i channel, and a is a constant calculated by an optimization algorithm. The above equation 21 constructs a quadratic equation having zero intercept, such that it can simplify an operation process. The model accuracy is determined according to the degree of accuracy of a data value calculated by a drift curve. If the drift curve has the value of 1, this means a perfect modeling process. If the drift curve has the value of 0, this means that data is not modeled at all. An average value of a drift curve formed after performing model optimization is 0.962, such that it can be recognized that the modeling process is correctly performed.

The channel-independent values after modeling the channel-dependent values are acquired by the following equation 22:
R=R_{primary}−R_{g,error}−R_{b,error}
G=G_{primary}−G_{r,error}−G_{b,error}
B=B_{primary}−B_{r,error}−B_{g,error} [Equation 22]

If the values calculated by the above equation 22 are used as input signals for channel-independent inverse characterization, the same input values are applied to three channels corresponding to the RGB channels although nine electricity-to-light I/O curves are different from each other, such that output values of the three channels are also different from each other. Therefore, the above-mentioned values including channel-independent electricity-to-light I/O curves of three channels must be converted into other values corresponding to the electricity-to-light I/O curves of nine channels. A difference between the channel-independent electricity-to-light curves of the nine channel and the electricity-to-light curves of the three channels can be represented by the following equation 23:
ΔRᵢ=R_{i,forward}−R=b_{r,i}(R)−b_{r,i}(R)
ΔGᵢ=G_{i,forward}−G=b_{g,i}(G)−b_{g,i}(G)
ΔBᵢ=B_{i,forward}−B=b_{b,i}(B)−b_{b,i}(B) [Equation 23]

In the above equation 23, ΔCᵢ (C=R, G, and B, i=X, Y, Z) is indicative of a difference between channel-independent electricity-to-light I/O values of nine channels and channel-independent values of nine channels, C_{i,forward} is indicative of electricity-to-light I/O values of nine channels, estimated in the characterization process, and b is indicative of a constant calculated by an optimization algorithm to maintain characteristics between channels. If a corrected value based on channel characteristics and channel-dependent values are added to channel-independent values, the same I/O curve as the electricity-light I/O curve of the nine-channel-independent characterization is formed. If an inverse process of the electricity-to-light I/O curves of nine channels is performed using GOG variables for use in the characterization process, digital values of a display device can be estimated by the following equation 24:
dᵣᵢ=[(2^{N}−1)/k_{g,ri}]((R+ΔRᵢ)^{1/γ}^{ᵣᵢ}−k_{o,ri}) if 0≦R≦1
d_{gi}=[(2^{N}−1)/k_{g,gi}]((G+ΔGᵢ)^{1/γ}^{_{gi}}−k_{o,gi}) if 0≦G≦1
d_{bi}=[(2^{N}−1)/k_{g,bi}]((B+ΔBᵢ)^{1/γ}^{_{bi}}−k_{o,bi}) if 0≦B≦1 [Equation 24]

In the above equation 24, d_{ci} (c=r, g, and b, i=X, Y, Z) is indicative of a digital value estimated by an inverse process of the electricity-to-light I/O curves of nine channels.

The above-mentioned digital value estimated by an inverse process of the electricity-to-light I/O curves of nine channels includes an error, such that three values are different from each other. Three digital values for each of RGB channels are weighted by the ratio of the maximum tri-stimulus values of primary-color RGB channels, such that the last digital values are determined. The higher the maximum stimulus value, the less the error sensitivity. Therefore, digital values estimated by weighting the maximum stimulus values are considered to have high accuracy.

$${d}_{r} = \sum {d}_{ri} \times \frac{{i}_{r , max}}{{X}_{r , max} + {Y}_{r , max} + {Z}_{r , max}} \\ {d}_{g} = \sum {d}_{gi} \times \frac{{i}_{g , max}}{{X}_{g , max} + {Y}_{g , max} + {Z}_{g , max}} \\ {d}_{b} = \sum {d}_{bi} \times \frac{{i}_{b , max}}{{X}_{b , max} + {Y}_{b , max} + {Z}_{b , max}} \qquad [ Equation 25 ]$$

In the above equation 25, Xₘₐₓ, Yₘₐₓ, and Zₘₐₓ are indicative of CIEXYZ values of the output light generated when the highest digital value is applied to individual channels as an input signal.

With reference to the characterization accuracy, an inverse characterization result is equal to an original image. In more detail, the less the error of a conversion process, the higher the model accuracy. As a result, the loss of a resultant image is reduced, as can be seen from a method for reproducing an image background and a human face color.

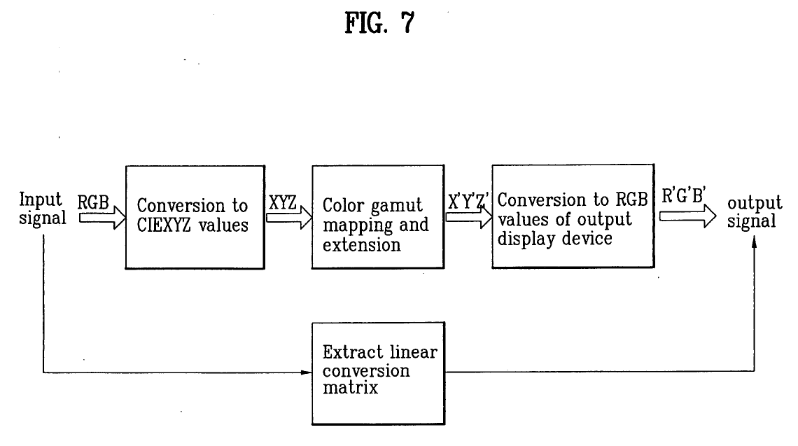

Input RGB signals are converted into CIEXYZ values, a chromatic adaptation conversion process and a color gamut mapping and expansion process are performed, and the last R′G′B′ values (corresponding to the CIEX′Y′Z′ values) of a display device, are estimated using the display characterization. In order to apply the above-mentioned process to a DTV system, the conversion relationship between input RGB values and the last output R′G′B′ values is estimated, resulting in increased system efficiency. FIG. 7 shows an overall process for modeling an I/O relationship equation.

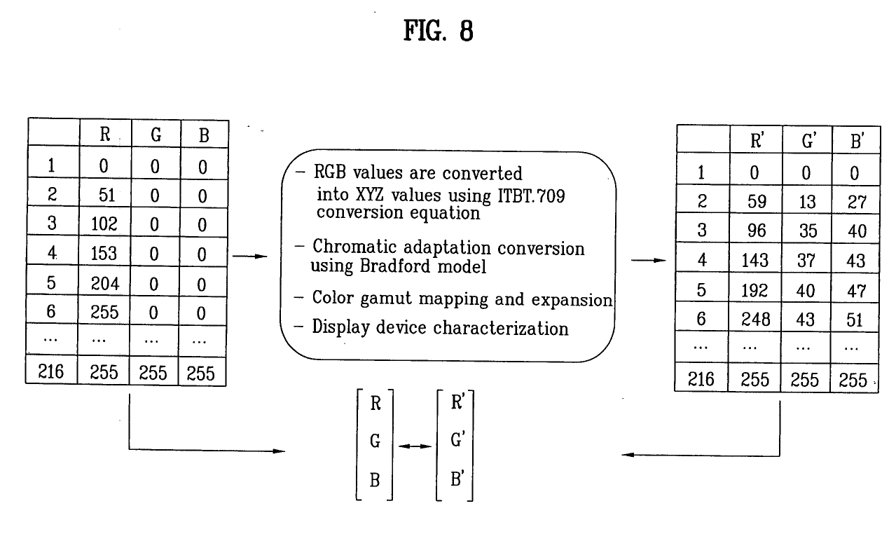

In order to estimate the above-mentioned conversion relationship equation, each stage is divided into six stages in R, G, and B areas, and 216 data units are converted into CIEXYZ values according to the ITUBT.709 conversion equation. The Bradford model is applied to the CIEXYZ values to perform the chromatic adaptation conversion, such that CIEX′Y′Z′ values are acquired, and then CIEX″Y″Z″ values are obtained by the color gamut mapping and expansion process. If the CIEX″Y″Z″ values are applied to the display device acting as the last output end, the last R′G′B′ values corresponding to the CIEX″Y″Z″ values can be acquired due to output device characterization. FIG. 8 is a flow chart illustrating a method for acquiring output R′G′B′ values corresponding to 216 RGB samples.

The relationship equation between the input RGB values and the last output R′G′B′ values can be estimated by a polynomial regression equation. The polynomial regression equation configures the relationship between input and output values in the form of a polynomial regression equation, such that a coefficient is measured using the configured polynomial regression equation. In more detail, a relationship function between RGB values and the last output R′G′B′ values corresponding to the RGB values is defined in a polynomial equation, and a coefficient of the polynomial equation is estimated, such that the conversion relationship between the RGB values and the R′G′B′ values can be established.

The polynomial regression equation is shown in the following equation 26:

$${R}^{′} ( R , G , B ) = {a}_{x , 0} + {a}_{x , 1} R + {a}_{x , 2} G + {a}_{x , 3} B + {a}_{x , 4} RG + {a}_{x , 5} GB + {a}_{x , 6} GR + {a}_{x , 7} {R}^{2} + {a}_{x , 8} {G}^{2} + {a}_{x , 9} {B}^{2} + {a}_{x , 10} RGB + {a}_{x , 11} {R}^{3} + {a}_{x , 12} {G}^{3} + {a}_{x , 13} {B}^{3} + {a}_{x , 14} {RG}^{2} + {a}_{x , 15} {R}^{2} G + {a}_{x , 16} {GB}^{2} + {a}_{x , 17} {G}^{2} B + {a}_{x , 18} {BR}^{2} + {a}_{x , 19} {B}^{2} R \\ {G}^{′} ( R , G , B ) = {a}_{y , 0} + {a}_{y , 1} R + {a}_{y , 2} G + {a}_{y , 3} B + {a}_{y , 4} RG + {a}_{y , 5} GB + {a}_{y , 6} GR + {a}_{y , 7} {R}^{2} + {a}_{y , 8} {G}^{2} + {a}_{y , 9} {B}^{2} + {a}_{y , 10} RGB + {a}_{y , 11} {R}^{3} + {a}_{y , 12} {G}^{3} + {a}_{y , 13} {B}^{3} + {a}_{y , 14} {RG}^{2} + {a}_{y , 15} {R}^{2} G + {a}_{y , 16} {GB}^{2} + {a}_{y , 17} {G}^{2} B + {a}_{y , 18} {BR}^{2} + {a}_{y , 19} {B}^{2} R \\ {B}^{′} ( R , G , B ) = {a}_{z , 0} + {a}_{z , 1} R + {a}_{z , 2} G + {a}_{z , 3} B + {a}_{z , 4} RG + {a}_{z , 5} GB + {a}_{z , 6} GR + {a}_{z , 7} {R}^{2} + {a}_{z , 8} {G}^{2} + {a}_{z , 9} {B}^{2} + {a}_{z , 10} RGB + {a}_{z , 11} {R}^{3} + {a}_{z , 12} {G}^{3} + {a}_{z , 13} {B}^{3} + {a}_{z , 14} {RG}^{2} + {a}_{z , 15} {R}^{2} G + {a}_{z , 16} {GB}^{2} + {a}_{z , 17} {G}^{2} B + {a}_{z , 18} {BR}^{2} + {a}_{z , 19} {B}^{2} R \qquad [ Equation 26 ]$$

The input RGB values and the output R′G′B′ values can be calculated by the above equation 26, such that coefficients ax of 0˜19 are estimated.

The correct conversion relationship can be induced according to the number of coefficients estimated by the above equation 26. The higher the number of coefficients to be estimated, the higher the conversion performance. However, there is a disadvantage in that a conversion equation and an algorithm are complicated.

A linear calculation process is required to calculate coefficients of individual terms. Therefore, in the case of constructing a necessary equation in the form of a matrix, the following equation 27 is provided.
P=V^{T}a [Equation 27]

In the above equation 27, P is indicative of 216 final output R′G′B′ values, and can be denoted by the following equation 28:

$$P = [ \begin{matrix}{R}_{1}^{′} & {G}_{1}^{′} & {B}_{1}^{′} \\ ⋮ & ⋮ & ⋮ \\ {R}_{n}^{′} & {G}_{n}^{′} & {B}_{n}^{′}\end{matrix} ] \qquad [ Equation 28 ]$$

In the above equation 27, V is input RGB values, and is equal to combination of RGB values, and is able to generate a total of 20 data units.

$$V = [ \begin{matrix}{1}_{1} & ⋯ & {1}_{n} \\ {R}_{1} & ⋯ & {R}_{n} \\ {G}_{1} & ⋯ & {G}_{n} \\ {B}_{1} & ⋯ & {B}_{n} \\ & ⋮ & \\ {G}_{1}^{2} {B}_{1} & ⋯ & {G}_{n}^{2} {B}_{n} \\ {B}_{1} {R}_{1}^{2} & ⋯ & {B}_{n} {R}_{n}^{2} \\ {B}_{1}^{2} {R}_{1} & ⋯ & {B}_{n}^{2} {R}_{n}\end{matrix} ] \qquad [ Equation 29 ]$$

In the above equation 29, a is a coefficient value to be estimated, is determined according to the combination of used RGB values, and is calculated by the following equation 30:

$$a = [ \begin{matrix}{a}_{x , 0} & {a}_{y , 0} & {a}_{z , 0} \\ ⋮ & ⋮ & ⋮ \\ {a}_{x , 19} & {a}_{y , 19} & {a}_{z , 19}\end{matrix} ] \qquad [ Equation 30 ]$$

Therefore, a complete inverse transform is not established in the coefficient to be estimated, such that the coefficient can be acquired by a pseudo inverse transform process shown in the following equation 31.
a=(VV^{T})⁻¹(VP) [Equation 31]

In the above equation 31, V^{T} is a transpose matrix.

Therefore, a conversion matrix between input RGB values and the last output R′G′B′ values is calculated using only coefficient values of the acquired polynomial regression equation. A value corresponding to a predetermined input image can also be acquired using the above-mentioned conversion matrix. In other words, the relationship between the input RGB values and the last output R′G′B′ values can be established using coefficients of the polynomial regression equation.

In order to reproduce the same color in different input devices, final_R, final_G, and final_B values indicative of the last output signals are estimated on the basis of the ITUBT.709 signal. R′G′B′ values acquired from a predetermined camera A are converted into the final_R, final_G, and final_B values upon receipt of the above-mentioned estimation result. R″G″B″ values acquired from a camera B are also converted into the final_R, final_G, and final_B values.

The Macbeth Colorchecker image is converted into the standard image, and the standard image is considered to be the ITUBT.709 broadcast signal, such that the RGB values are converted into CIEXYZ values. The CIEXYZ values are applied to a color operation/management system, and the display characterization process is applied to the resultant CIEXYZ values, such that the last R′G′B′ values are acquired. The last R′G′B′ values are defined as standard RGB values to be displayed on a target display in association with the standard input signals. The relationship for converting RGB values acquired from another input device into the standard RGB values is estimated, a process for achieving color coincidence between input devices is carried out.

In order to acquire RGB values under the standard light source from a camera acting as an input device, RGB values of each patch contained in an image captured by the camera are calculated by averaging values corresponding to 80% of the patch size, such that the averaged values are used as representative values of each patch. If the averaged values are applied to individual patches, noise of the camera and distortion caused by the light source can be compensated for. Under the same environment as the above, a specific is captured by Sony and Olympus cameras, and each of R′G′B′ values and each of R″G″B″ values can be acquired.

It is assumed that the R′G′B′ values acquired by the Sony camera and the R″G″B″ values acquired by the Olympus camera are ITUBT.709 signals, and final R′G′B′ values to be generated are estimated using a polynomial regression equation.

A conversion function A is indicative of the relationship function between R′G′B′ values of the image acquired by Sony camera and the final R′G′B′ values of the last output end. A conversion function B is indicative of the relationship function between R″G″B″ values of the image acquired by the Olympus camera and the final R′G′B′ values of the last output end. Individual conversion functions A and B can be estimated by repeating the above-mentioned process.

It is assumed that the input signals are ITUBT.709 HDTV standard broadcast signals, and the input signals are indicated according to PDP and LCD display characteristics in such a way that a process for reproducing the same color can be carried out. The display output devices generate RGB values depending on device categories using a chromatic adaptation conversion process, a color gamut mapping and expansion process, and conversion functions of the GOG model of nine channels.

In order to correctly compare the Macbeth graphic image with the resultant images of the PDP and the LCD, characterization results are displayed on the display devices, and a process for determining if the same color is reproduced on individual display devices must be performed. If the same input signal is applied to the PDP, a chroma of the resultant image is relatively less than that of the LCD. Provided that the PDP resultant image has a high chroma and is applied to the PDP, the resultant image is similar to that of the LCD. The same color is reproduced in the PDP and the LCD, the resultant image of the PDP has a chroma higher than that of the LCD resultant image, and the PDP resultant image is actually used. As a result, the PDP resultant image is similar to the LCD resultant image.

In order to reproduce the same color in display devices, the Bradford chromatic adaptation model, the color gamut mapping and expansion process on xy chromatic planes, and the characterization process of the display devices are used, such that devices' RGB values corresponding to the standard color stimulus values can be acquired. The standard color stimulus values are identically displayed on the display devices on the basis of the RGB values of the display devices, such that a color coincidence process between display devices is performed. If resultant values formed when the same RGB values are applied to individual display devices are compared with other values formed when RGB values of individual display devices are applied to the display devices, it can be noted that the similar color reproducibility is provided.

In order to reproduce the same color in display devices, the present invention receives signals having different white reference points, converts the standard color stimulus values of the received signals into the standard color stimulus value of a white point of the output device using the chromatic adaptation model. In this experiment of the present invention, the chromatic adaptation conversion process is performed using the Bradford chromatic adaptation model authorized by the international illumination organization (CIE), resulting in increased accuracy. In order to process a DTV moving image signal, the color gamut mapping and expansion process is performed in xy planes having low complexity of the color gamut boundary setup and operation process, such that the DTV moving image signal is converted into the standard color stimulus value depending on output devices. The above-mentioned color gamut mapping and expansion technique adjusts input signals to be suitable for the output color gamut. As a result, a desired color is constantly maintained in xy planes, a chroma is enhanced, and a color expressible by a device can be effectively described.

The standard color stimulus values converted by the color operation/management system are converted into RGB values corresponding to individual devices using the nine-channel-inverse-characterization GOG model, such that color coincidence is established between display devices. The characterization process for nine channels is performed, and the overlapping between channels and the correlation between channels are established, such that the correct conversion relationship can be estimated.

In order to reproduce a desired color in a single display device independent of the input signals, individual RGB values acquired from a digital camera on the basis of the standard broadcast signal are converted into the standard RGB values, such that a color processing technique independent of the input signals is performed. An independent color processing technique is applied to the input signals and output display devices, such that a desired color can be reproduced independent of the DTV I/O device.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A color compensation method for use in a display device comprising the steps of:
(a) converting RGB values of a first video signal into first color stimulus values, respectively;
(b) performing a color gamut mapping and expansion process on the first color stimulus values in order to obtain second color stimulus values; and
(c) converting the second color stimulus values into a second video signal on the basis of property information of the display device.

2. The method according to claim 1, wherein the step (a) comprises the steps of:
(a1) sampling RGB values of the video signal; and
(a2) converting the sampled RGB values into the first color stimulus values.

3. The method according to claim 1, wherein the step (b) comprises the step of performing a color gamut mapping process on the first color stimulus values on the basis of a white reference point of the display device.

4. The method according to claim 1, wherein the step (b) comprises the steps of:
(b1) comparing a first color gamut of the first video signal with a second color gamut of the display device; and
(b2) performing a color gamut expansion process on the first color stimulus values according to a difference between the first color gamut of the first video signal and the second color gamut of the display device.

5. The method according to claim 1, wherein the step (c) comprises the step of converting the second color stimulus values into the second video signal using a nine-channel GOG (Gain Offset Gamma) model based on the property information of the display device.

6. The method according to claim 1, further comprising the step of (d) converting chromatic values of the first color stimulus values using a chromatic adaptation model of the display device.

7. The method according to claim 6, wherein the color adaptation model is one of Kries model and Bradford model.

8. A color compensation apparatus for use in a display device comprising:
a first video signal converter for converting RGB values of a first video signal into first color stimulus values;
a color gamut mapping and expansion unit for performing a color gamut mapping and expansion process on the first color stimulus values in order to obtain second color stimulus values; and
a second video signal converter for converting the second color stimulus values into a second video signal on the basis of property information of the display device.

9. The apparatus according to claim 8, wherein the first video signal converter samples RGB values of the first video signal, and converts the sampled RGB values into the first color stimulus values.

10. The apparatus according to claim 8, wherein the color gamut mapping and expansion unit performs a color gamut mapping process on the first color stimulus values on the basis of a white reference point of the display device.

11. The apparatus according to claim 8, wherein the color gamut mapping and expansion unit compares a first color gamut of the first video signal with a second color gamut of the display device, and performs a color gamut expansion process on the first color stimulus values according to a difference between the first color gamut of the first video signal and the second color gamut of the display device.

12. The apparatus according to claim 8, wherein the second video signal converter converts the second color stimulus values into the second video signal using a nine-channel GOG (Gain Offset Gamma) model based on the property information of the display device.

13. The apparatus according to claim 8, further comprising:
a color signal converter for converting chromatic values of the first color stimulus values using a chromatic adaptation model of the display device.

14. The apparatus according to claim 13, wherein the color adaptation model is one of Kries model and Bradford model.

15. The apparatus according to claim 8, wherein the second video signal converter comprises:
a matrix converter for dividing the second color stimulus values for a plurality of channels;
a brightness compensator for compensating for brightness values of the divided second color stimulus values; and
a plurality of modeling units for converting the divided second color stimulus values into image data of the second video signal using a plurality of modeling functions, which are preset for the plurality of channels, respectively.

16. A color compensation method for use in a display device comprising the steps of:
(a) performing a color gamut mapping and expansion process on first color stimulus values converted from RGB values of a first video signal in order to output second color stimulus values;
(b) dividing the second color stimulus values for a plurality of channels; and
(c) converting the divided second color stimulus values into a second video signal using a plurality of modeling functions, which are preset for the plurality of channels, respectively.

17. The method according to claim 16, wherein the step (b) comprises the step of dividing each of the second color stimulus values for three channels.

18. The method according to claim 16, further comprising the step of removing an interference component from each of the RGB values.
